(19) United States
(12) Patent Application Publication
(10) Pub. No.: US 2013/0270751 A1
(43) Pub. Date: Oct. 17, 2013

(54) Process for decreasing the mold residence time in extrusion blow molding

(71) Applicant: Earl Master Towzey, III, Montgomery, AL (US)

(72) Inventor: Earl Master Towzey, III, Montgomery, AL (US)

(21) Appl. No.: 13/199,467

(22) Filed: Aug. 31, 2011

Related U.S. Application Data
(60) Provisional application No. 61/379,415, filed on Sep. 2, 2010.

(51) Int. Cl. B29C 49/66; B29C 49/78

(52) U.S. Cl. 264/528; 425/149

(57) ABSTRACT

A process for decreasing the mold residence time in extrusion blow molding, wherein pressurized air is used to expand a plastic into a blow molded article. The process comprises providing an extrusion blow molding mold having a mold cavity, with an air inlet into the mold cavity. Then, providing pressurized air to the mold cavity through the air inlet during the blow molding of the article such that the plastic expands to the mold walls, then, providing a pressurized liquefied gas, such that the expanded plastic is cooled by the liquefied gas, whereby the residence time in the mold cavity is decreased.

This application claims priority from U.S. Provisional Patent application Ser. No. 61/379,415, filed on Sep. 2, 2010 which is incorporated herein by reference in its entirety.

### BACKGROUND OF THE INVENTION

Extruded blow mold articles are manufactured by melting a thermoplastic material and extruding it under high pressure through a die and mandrel forming a molten parison curtain. The molten parison is blown into the shape of the article using high pressure air.

In the process, there is a need to cool the inside of the mold cavity and the article in the mold to solidify the article in the desired shape. The cooling of the blown articles is limited to the cooling of the exterior side of the blown article as there is no known process for cooling the insides of such articles in an extrusion blow molding process. In addition to providing the shape of the article, the molds also serve the function of cooling the article.

The molds are cooled by plumbing a heat transfer fluid (usually cooling water, chilled water or a mixture of chilled water and glycol) to the jacket of the mold. There is some prior art that uses cooled air to blow a container producing a blown article that is initially slightly cooler than using air at elevated temperatures. However, this is of marginal benefit as the air is quickly warmed by the parison and offers no continuing benefit. There is some injection molding processes that use a continuing flow of liquefied gas blowing on the exterior of the article to provide some convective cooling affect. The cooling of the blown article is usually the single longest part of the blow molding cycle. It can thus be observed, that it takes some extended period of time to cool articles in blow molding operations by these methods.

### THE INVENTION

Thus, what is disclosed and claimed herein is a process for decreasing the mold residence time in extrusion blow molding, wherein pressurized air is used to expand a plastic into a blow molded article.

The process comprises providing an extrusion blow molding mold having a mold cavity, with a liquefied gas inlet into the mold cavity. Then, providing pressurized air to the mold cavity through the liquefied gas inlet during the blow molding of the article and stretching the parison into the desired shape controlled by the interior mold surfaces. Also, providing a high pressure liquefied inert gas, to the interior of the blown article and allowing the liquefied gas to expand into a saturated gas at a reduced pressure, providing an evaporative cooling effect to the interior of the blown article.

In another embodiment, there is a system for molding an article from plastic by extrusion blow molding, the system comprising an extrusion blow molding system, wherein the system has a mold. The mold has a mold cavity, and affixed in the mold cavity, a means of providing pressurized molding air and high pressure liquefied gas to the mold cavity.

There is a first control valve and a control on the inlet of the mold used to control the flow of blow air to the mold cavity through the blow pin body. There is at least one outlet port out of the mold for release of air and liquefied gas from the mold. The outlet is timed with the blow molding cycle to remain closed until after the article is blown and cooled.

In yet another embodiment, there is a control component for providing high pressure liquefied gas to an extrusion blow molding system. There is a control component comprising a first valve on the inlet of the mold and a control for a first valve to control the flow of liquefied gas entering a mold cavity. There is also a restricting orifice, expansion valve, control valve or other throttling device used to drop the pressure of the liquefied gas allowing it to expand into a saturated gaseous state at very low temperatures, instantaneously into the interior of the blown article. In addition, there is at least one outlet for release of the air and gas.

### BRIEF DESCRIPTION OF THE DRAWINGS

FIG. 1 is schematic of existing state of the art showing a typical operation to provide high pressure blow air to the mold cavity and its release.

FIG. 2 is a schematic of the invention showing the operation to provide high pressure air and high pressure liquefied gas to the mold cavity, and the release.

### DETAILED DESCRIPTION OF THE INVENTION

Liquefied gases useful in this invention include any inert liquefied gas such as nitrogen, carbon dioxide, argon or refrigerant liquefied gases such as Freon. In this invention, blow air is introduced to the mold cavity to blow the container shape. The blow air is then shut off. The liquefied gas is then introduced into the mold cavity used by blow molding machines while simultaneously opening the controlled pressure vent.

The pressure of the liquefied gas is instantaneously reduced across the throttling device allowing it to evaporate and cool into a saturated gas at very low temperatures on the order of about 0° F. to about −100° F. The controlled pressure vent allows a continuous flow of the liquefied gas quickly displacing the blow air from the interior of the blown article and the evaporative cooling affect quickly cooling of the article from the inside out while the mold cools the article from the outside in.

Because extrusion blow molding cycle times are limited to how quickly the article can be cooled in order to remove the flash, this invention is a significant step forward in providing reduced cycle times for blow molding operations, and especially for blow molding containers.

In this invention, it is necessary to modify traditional blow molding systems. Blow molding systems typically operate by providing a parison of molten plastic to the mold cavity, which are two separated halves. The parison is clamped by the two halves of the mold coming together and then compressed air is injected into the clamped parison, which forces the soft plastic out against the inside configuration of the mold cavity. Since the mold is cooled by cooling water flowing through its jacket and the parison is cooled from contact with the mold wall, it takes a few seconds for the re-configured parison to cool and stabilize.

This invention provides cooling to the inside of the blown article in addition to the cooling provided by the molds to the external sides. The container is blown using high pressure air blown into the center of the molten parison stretching the polymer to the mold walls. Then liquefied gas is introduced to the center of the parison cooling as it expands into a gaseous state.

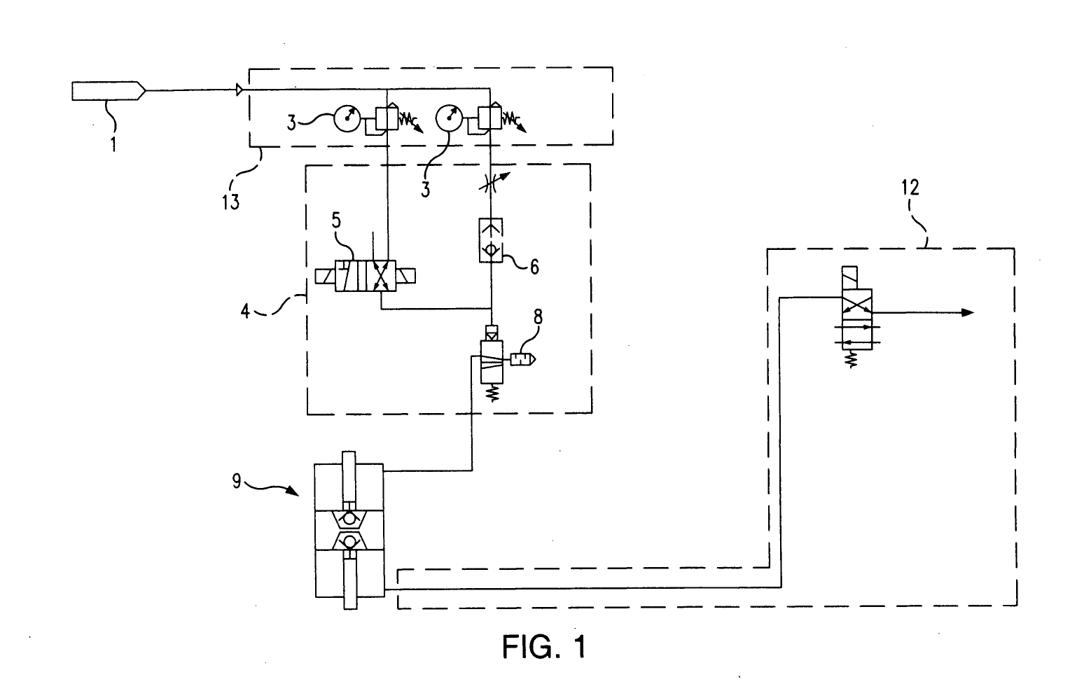

Turning now to FIG. 1, there is shown a typical schematic of a blow molding operation using high pressure air, wherein there is shown a source of high pressure air 1, control of such air by timers (not shown) thorough pressure reducing valves 3 and the like in a control module 13, to an air manifold assembly 4 containing two solenoid valves 5 and 8. Valves 5 and 8 control the main air supply for the blow air and valve 8 controls pre-blow air. The air is moved to one or more blow pin bodies 9. Blow pin bodies 9 are the components that actually provide the air to the parison. During injection of the air, the blow pin cylinders 9 project downwardly in the mold, into the soft plastic. As soon as the article has expanded to the walls of the mold and has been cooled, the blow pin cylinders 9 rise out of the molded article and the pressurized air is released and vented into the atmosphere as is shown by the vent and release assembly 12. It is contemplated within the scope of this invention to allow the pressure to release without any control therefor.

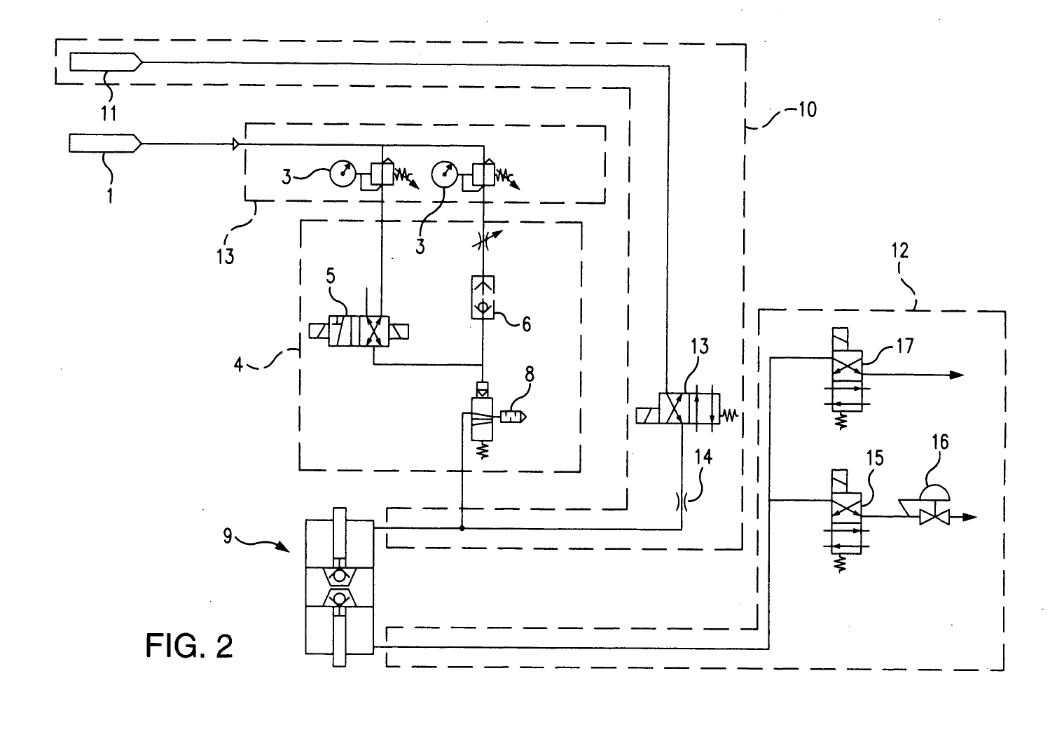

The same movement is used for providing the liquefied gas to the parison/molded article as can be observed from FIG. 2. In addition to the high pressure air assembly, there is a liquefied gas assembly 10 shown therein in which the liquefied gas source 11 supplies liquefied gas to the blow pin bodies 9. Note that the high pressure air supply is merged (point P) with the liquefied gas supply prior to providing either to the blow pin bodies 9.

In this invention, a source tank of the liquefied gas to be used is plumbed into the molding operation such that the liquefied gas can enter the parison through the same inlet tube. The equipment will also need to be equipped with a liquefied gas control valve 13 that will control the flow of liquefied gas to the interior of the blown article and a throttling device 14 that is used to instantly drop the pressure of the liquefied gas expanding it to a saturated gas. Control valve 15 and pressure control 16 for the release of the air and expanded gas mixture from the mold cavity at some pressure below the pressure of the blow air and the pressure of the liquefied gas. This allows for the continuous flow and evaporation of the liquefied gas into the mold cavity during the cooling cycle.

There is also a control valve 17 timed with the blow mold cycle to open after closing the inlet of the air and the liquefied gas for the release of pressure in the mold cavity at the conclusion of the cooling cycle and prior to the opening of the molds and release of the blown article.

The liquefied gas valve should be mounted close to the blow pins on the blow molding machine (from about 4 to 6 feet) in order to provide instantaneous entry of the liquefied gas when needed. Flexible tubes or lines convey the liquefied gas from the source tank to the valve and from the valve to each blow pin adapter on the blow molder. The liquefied gas should be adjustable between 60 psi and 120 psi to be effective.

Also, the same set up should be provided for the high pressure blowing air. As can be observed, each blow pin cylinders 9 should have two inlets, one for compressed air, and one for the liquefied gas. Two timers (not shown) have to be placed into the controller of the blow molder. One is for pre blow air which is turned on as the parison is extruded in order to position it for molding. The second controls the blow air used to stretch the parison. The pre blow air and blow air are turned off by the timers immediately after the article is blown. An additional timer opens the control valve on the liquefied gas and simultaneously opens the pressure controlled vent valve. This allows for the continuous flow of liquefied gas into the blown article. A throttling device on the inlet of the liquefied gas instantly drops the pressure of the liquefied gas allowing it to evaporate and cool. This quickly displaces the blow air and cools the article from the inside out. Once the article is cooled the time closes the control valve on the liquefied gas inlet and opens the vent valve releasing the pressure to the atmosphere. The molds then open and the cooled article is then removed from the molds.

Thus, the blow molding machine will call for the liquid liquefied gas immediately following the blow portion of the cycle and then disposes of the liquefied gas to the atmosphere along with the compressed air from inside the molded article after cooling is complete.

It is contemplated within the scope of this invention to provide the liquefied gas flow into the flow of the compressed air through a common manifold, instead of providing the liquefied gas and air to the blow pin bodies. This would require a backflow preventer to be installed between the main blow valve and the liquid insert liquefied gas line attached to the manifold.

The timing of this operation is such that the compressed air to the parison happens first, as a direct flow of the liquefied gas without the air would result in freezing the parison such that it could not be expanded. Thus, the general order is that the blow molder will call for the liquefied gas; it expands when the valves open, traveling down into the blow manifold or the blow pins, mixing with the compressed air and cooling the air to between −40° F. and −100° F. The super cooled liquefied gas/ air mixture hits the previously stretched parison that is against the mold cavity wall, cooling it very rapidly.

When the timers finish, the air/liquefied gas mixture exhausts to the atmosphere. The blown articles come out of the machine colder than standard machine operations can perform. The CPU of an extrusion blow molding machine will call for the liquid liquefied gas. There is no need for human interaction except to set the parameters of the machine. Using liquefied gas has no affect on the blown article other than super cooling it. Current cooling is limited to how cold the compressed air can be made, or how cold the molds can be kept.

Current blow molding machines cool the container predominately from the outside using chilled water to cool the mold. Chilled water is generally limited to 20 to 44 degrees Fahrenheit. It cannot go any colder without risking freezing the chilled water lines and causing icing of the mold cavities and, cause related process issues such as condensation on the molds, causing water marks that weaken the structure of the molded article. Providing chilled water at these temperatures is very costly due to the energy required by the chiller to cool the heat transfer fluid.

The use of this invention makes the temperature of the atmosphere inside of the article between −40 and −100° F. very quickly. The faster you move the formed article temperature down to ambient room temperature or lower, the faster it can come out of the mold and be trimmed, and be prepared to package and sell.

This invention can dramatically decrease the cycle time required to produce a blow molded article. This can lower the required capital outlay to achieve a given capacity. In addition, the faster cooling can be used to lighten the container saving raw material which is the single largest cost of the container. And finally, the faster cooling allows the neck of the container to be formed more constantly eliminating downstream processing issues.

Liquefied gases are relatively inexpensive and are readily available in the market place.

What is claimed is:

1. A process for decreasing the mold residence time in extrusion blow molding, wherein pressurized air is used to expand a plastic into a blow molded article, the process comprising:
a. providing an extrusion blow molding mold having a mold cavity, with a liquefied gas inlet into the mold cavity;
b. providing pressurized air to the mold cavity through the liquefied gas inlet during the blow molding of the article such that a plastic parison is expanded to the walls of the mold;
c. then pressurizing the expanded article with liquefied gas, whereby the article is cooled by the evaporative cooling effect of the expanding, liquefied gas, whereby the residence time in the mold cavity is decreased.

2. A system for molding an article from plastic by extrusion blow molding, the system comprising:
a. an extrusion blow molding system, said system having a mold, said mold having a mold cavity, and affixed in the cavity, a means of providing pressurized molding air and liquefied gas to the mold cavity and a plastic parison;
b. a first valve and a control for the first valve to control flow of air entering the parison to be molded;
c. a second control valve to control the second control valve to control the flow of liquefied gas entering the molded article;
d. a throttling device for dropping the pressure of the liquefied gas and allowing it to expand to a saturated gas;
e. a third valve and a control for the third valve to control the pressure within the molded article and the mold cavity and to control the release of air and liquefied gas from the mold cavity;
f. at least one outlet port out of the mold for release of air and expanded gas from the mold, the first valve and the second valve being timed with the mold cycle of the extrusion blow molding system.

3. A control component for providing a liquefied gas to an extrusion blow molding system, the control component comprising:
a. a first valve and a control for a first valve to control the flow of liquefied gas entering a mold cavity and a molded article;
b. a second valve and a control for the second valve to control the pressure within the mold cavity and the molded article;
c. a throttling device for dropping the pressure of the liquefied gas and allowing it to expand to a saturated gas;
d. at least one outlet port out of the mold for release of air and liquefied gas from the mold;
e. the first valve and the second valve being timed with the mold cycle of the extrusion blow molding system.
